(19) United States
(12) Patent Application Publication
(10) Pub. No.: US 2020/0127380 A1
(43) Pub. Date: Apr. 23, 2020

(54) ANTENNA FOR MOBILE COMMUNICATION DEVICE

(71) Applicant: STMicroelectronics (Tours) SAS, Tours (FR)

(72) Inventor: Benoit BONNET, Tours (FR)

(73) Assignee: STMicroelectronics (Tours) SAS, Tours (FR)

(21) Appl. No.: 16/653,361

(22) Filed: Oct. 15, 2019

(30) Foreign Application Priority Data
Oct. 22, 2018 (FR) 1871258

(51) Int. Cl. H01Q 9/04; H01Q 1/24; H01Q 1/48

(52) U.S. Cl. CPC H01Q 9/0442; H04B 1/3833; H01Q 1/48; H01Q 1/241

(57) ABSTRACT

An antenna includes an elongated conductive strip to which at least one capacitive element of adjustable capacitance and at least one inductive element are electrically coupled. The at least one capacitive element is coupled between the strip and ground. The at least one inductive element is switchable in parallel with the at least one capacitive element. The elongated conductive strip is integral with a periphery of a device shell. Adjustment of capacitance and switching of inductance is dependent on device operation.

### PRIORITY CLAIM

This application claims the priority benefit of French Application for Patent No. 1871258, filed on Oct. 22, 2018, the content of which is hereby incorporated by reference in its entirety to the maximum extent allowable by law.

### TECHNICAL FIELD

The present disclosure generally relates to electronic devices and, more particularly, to antennas used by transmission circuits equipping mobile communication devices. The present disclosure more particularly aims at a planar inverted-F antenna (PIFA) for portable telecommunication equipment of mobile telephony type (smart phone or other).

### BACKGROUND

A mobile telephone antenna is generally arranged at the level of the telephone shell to avoid been shielded by metal elements. The antenna is then coupled to the electronic transmission circuits internal to the telephone.

The multiplication of frequency bands usable in mobile telephones and tablets as well as the multiplication of wire connectors (headphones, USB port, etc.) present on the telephone results in providing wideband frequency tunable antennas.

It would be desirable to have a radio frequency antenna architecture which can efficiently operate in different frequency bands.

It would be desirable to have a solution particularly adapted to the frequency bands used in mobile telecommunication devices.

It would be desirable to have a solution adapted to existing transmission circuits.

### SUMMARY

An embodiment overcomes all or part of the disadvantages of antennas for known mobile communication devices.

An embodiment provides an antenna more particularly adapted to devices integrating wire connection ports, for example, of USB type.

Thus, an embodiment provides an antenna comprising: an elongated conductive strip; at least one capacitive element of adjustable capacitance, coupling said strip to ground; and at least one switchable inductive element in parallel with the first capacitive element.

According to an embodiment, the antenna comprises at least two individually switchable inductive elements in parallel with the capacitive element.

According to an embodiment, the antenna comprises a controllable switch in series with said or each inductive element.

According to an embodiment, two switches respectively associated with two inductive elements are controllable according to four states: the two switches are off; a first one of the switches is on, the second switch being off; the second switch is on, the first switch being off; and the two switches are on.

According to an embodiment, the connection between the capacitive element and the inductive element(s) is direct and does not transit through a portion of the conductive strip.

According to an embodiment, the inductance value of the or of each inductive element is at least 5 nH, preferably, at least 10 nH.

According to an embodiment, the antenna forms a shorted quarter-wave antenna.

According to an embodiment, the antenna is sized for bandwidths in the range from approximately 610 MHz to approximately 960 MHz.

An embodiment provides a portable telecommunication device comprising at least one antenna.

According to an embodiment, the device comprises a USB connector in an opening of the conductive strip.

According to an embodiment, the device comprises a jack connector in an opening of the conductive strip.

According to an embodiment, the switching of the inductive element(s) depends on the use or not of the USB connector(s).

According to an embodiment, the method comprises a step of switching the inductive element(s) according to the activation of a component of the device, independent from the antenna.

According to an embodiment, the method further comprises a step of adjusting the capacitance of the capacitive element according to the activation of a component of the device, independent from the antenna.

According to an embodiment, the method further comprises a step of adjusting the capacitance of the capacitive element and/or a step of switching the inductive element(s) according to the frequency band desired for the antenna.

### BRIEF DESCRIPTION OF THE DRAWINGS

The foregoing and other features and advantages will be discussed in detail in the following non-limiting description of specific embodiments in connection with the accompanying drawings, wherein:

FIG. 1 is a block diagram of an example of radio frequency transmission chain of the type to which the embodiments which will be described apply;

FIG. 2 schematically shows a shorted quarter-wave antenna;

FIG. 3 schematically shows another shorted quarter-wave antenna;

FIG. 4 schematically shows an embodiment of a PIFA antenna;

FIG. 5 schematically shows another embodiment of a PIFA antenna;

FIG. 6 schematically shows a PIFA antenna such as shown in FIG. 4 in an example of environment;

FIG. 7 is a partial block diagram of a PIFA antenna tuning structure;

FIG. 8 illustrates an example of frequency response of a PIFA antenna such as shown in FIG. 6; and

FIG. 9 illustrates another example of frequency response of a PIFA antenna such as shown in FIG. 6.

### DETAILED DESCRIPTION

The same elements have been designated with the same reference numerals in the different drawings. In particular, the structural and/or functional elements common to the different embodiments may be designated with the same reference numerals and may have identical structural, dimensional, and material properties.

For clarity, only those steps and elements which are useful to the understanding of the described embodiments have been shown and are detailed. In particular, the operation and the structure of an entire radio frequency transmission chain have not been detailed, the described embodiments being compatible with usual transmission chains.

Throughout the present disclosure, the term “connected” is used to designate a direct electrical connection between circuit elements with no intermediate elements other than conductors, whereas the term “coupled” is used to designate an electrical connection between circuit elements that may be direct, or may be via one or more intermediate elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., unless otherwise specified, it is referred to the orientation of the drawings.

The terms “approximately”, “substantially”, and “in the order of” are used herein to designate a tolerance of plus or minus 10%, preferably of plus or minus 5%, of the value in question.

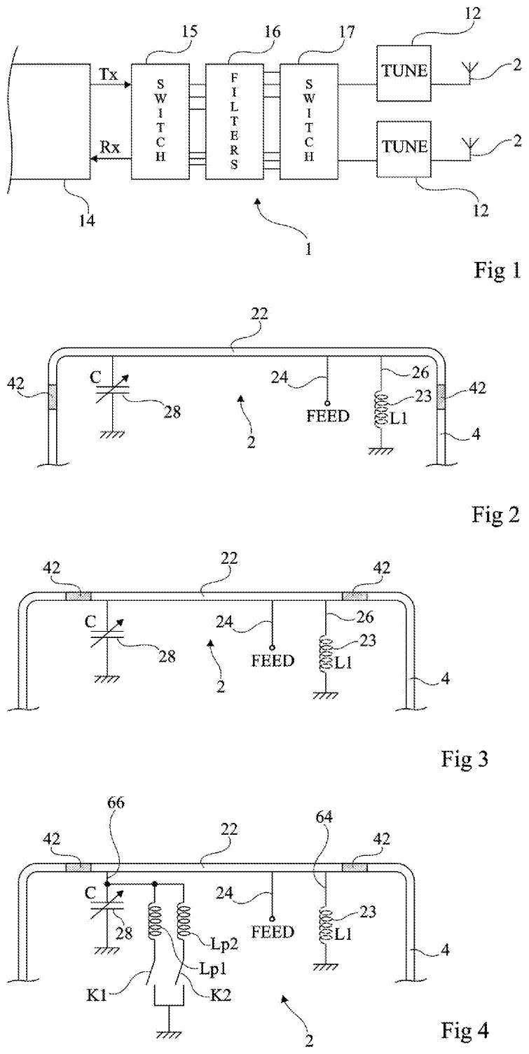

FIG. 1 is a block diagram of an example of a radio frequency transmission chain 1 of the type to which the embodiments which will be described apply.

Such a chain is, in the applications targeted by the present description, multifrequency in transmit and receive mode. One or (most often) a plurality of antennas 2 are individually connected to frequency tuning circuits 12 (TUNE).

In transmit mode, signals Tx to be transmitted are generated by electronic circuits 14 and are supplied by one or a plurality of power amplifiers (PA) to a network 15 of switches (SWITCH) having the function of branching the signals towards a filter of a network 16 of filters (FILTERS) according to the considered frequency band. The outputs (in transmit mode) of filters of the network 16 are coupled to a network 17 of antenna switches (SWITCH) in charge of selecting the output of the filter used and of coupling it to circuit 12 for tuning an antenna 2.

In receive mode, the received signals Rx follow a similar but reverse path, from circuit 12 of antenna 2 capturing the signals in the appropriate frequency band, through switch network 17, to be filtered by one of the filters of network 16, and then branched by switch network 15 towards a receive amplifier, generally a low-noise amplifier (LNA) of circuit 14.

FIG. 2 schematically shows a shorted quarter-wave antenna.

FIG. 3 schematically shows another shorted quarter wave antenna.

FIGS. 2 and 3 are simplified representations of shorted quarter-wave antennas, also called Inverted-F antennas, which are more particularly targeted by the described embodiments. Indeed, this type of antennas is that generally used in mobile telephones (smart phones) and tablets. More specifically, the antennas which are preferably targeted are PIFA antennas (Planar Inverted-F Antenna) which are formed from a conductive plane, often in the form of a planar conductive strip 22, applied on the inner surface or forming a portion of a peripheral region of a shell 4 of the telephone. In the last case, conductive strip 22 is then insulated from the rest of shell 4 by electrically-insulating portions 42 thereof.

FIGS. 2 and 3 illustrate examples of antennas 2 formed on a small side of the periphery of shell 4 of a telephone. The case of a telephone having a generally rectangular shape is considered. These drawings schematically show cross-section views of a portion of shell 4 of the telephone.

FIG. 2 illustrates the case of an antenna 2 having a length requiring for it to protrude from the small side. Antenna 2 thus partially extends on the lateral edges of shell 4.

FIG. 3 illustrates the case of an antenna 2 having a length such that it is integrally contained within the small side of the periphery of shell 4.

A PIFA antenna comprises at least:
an elongated conductive strip 22;
an antenna feed 24 (FEED) configured to be connected to the telephone circuits (in receive or in transmit mode), for example, to a circuit 12 or directly to network 17 of FIG. 1; and
a ground connection 26 (direct or via an inductive element 23 shown in dotted lines).

Feed 24 and connection 26 are arranged in a same side of strip 22, typically in the same half of strip 22. Connection 26 is either direct and equivalent to a parasitic inductive element 23, or via an inductive element 23 of inductance L1 coupling strip 22 to ground.

In PIFA antennas targeted by the present description, which are multiband antennas, antenna 2 further comprises a capacitive element 28 of adjustable capacitance C (PTIC—Parascan Tunable Integrated Capacitor) coupling strip 22 to ground. The connection of capacitive element 28 to strip 22 is located in the other half of the length of strip 22 with respect to that receiving feed 24 and connection 26. Feed 24 may be on one side or the other of connection 26 with respect to element 28. Capacitive element 28 is controlled by circuits 14 (FIG. 1) according to the desired operating frequency band(s).

For an antenna, the bandwidth is defined for a voltage standing wave ratio (VSWR) of 3, which is equivalent to return losses (RL) of 6 dB. In other words, this corresponds to the frequency band where at least 75% of the power is transmitted to the antenna.

The respective positions of connection 26 and of capacitive element 28 as well as the respective values of inductance L1 and of capacitance C condition the resonance frequency of antenna 2, otherwise set by the size of strip 22. In simplified fashion, with no capacitive element and with connection 26 to the end of strip 22, the sum of the length and of the width of a rectangular strip 22 corresponds to one quarter (λ/4) of the wavelength. Capacitive element 28 enables to decrease the size of strip 22. Still in simplified fashion, the position of feed 24 relative to the end of strip 22 conditions the reflection coefficient of antenna 2. In practice, the designer of antenna 2 performs many simulations to determine the respective positions and values of connections 24 and 26 and of element 28.

With the frequency bands used in mobile telephony, antennas such as illustrated in FIGS. 2 and 3 do not enable to obtain a sufficient bandwidth to cover both the low frequencies and the high frequencies of mobile telecommunication standards.

Typically, to cover the frequency bands of the 4G, or even 5G, standards, the operating frequency band of the antenna has to be widened towards high frequencies (2.17 GHz for 3G to 2.7 GHz for 4G, and then to 3 GHz or more for 5G). Further, for 4G, it is desired to have a bandwidth going down to approximately 700 MHz and for 5G, it is desired to have a bandwidth going down to approximately 500 MHz.

It is further now desired for telephones to be able to simultaneously capture or cover a plurality of frequency bands (carrier aggregation) to be able to increase the bandwidth and the data communication rates. This is in particular true for the 4G and 5G standards.

To obtain a wideband antenna, it is known from United States Patent Application Publication No. 2018/0205137 (EP-A-3352301) to add an inductive element close to variable-capacitance capacitive element 28. According to the implementations of this teaching, an inductive element couples, close to capacitive element 28, strip 22 to ground. Close means that the distance between the respective connection points of the inductive element and of element 28 to strip 22 is shorter than the distance between the connection point of the inductive element and the connection to ground 26.

A PIFA antenna may however be close to external connectors of the telephone, for example, a headphone socket, a power socket, a USB, mini USB, micro USB, USB OTG (On-The-Go) port, etc. The presence of such a connection may disturb the radio frequency operation. In particular, when such a connection is used, this modifies the voltage standing wave ratio of the antenna and shifts it to lower frequencies. The desired bandwidths are therefore not achieved, in particular for frequencies smaller than one GHz.

The embodiments described hereafter provide new antenna architectures aiming not only at improving the bandwidth for a given conductive strip size, imposed by the constraints of shell 4 of the telephone or, more generally, by the space available for antenna 2, but also at enabling a compensation according to whether an external connector, for example, a USB/OTG port or connector, is or not used.

FIG. 4 schematically shows an embodiment of a PIFA antenna.

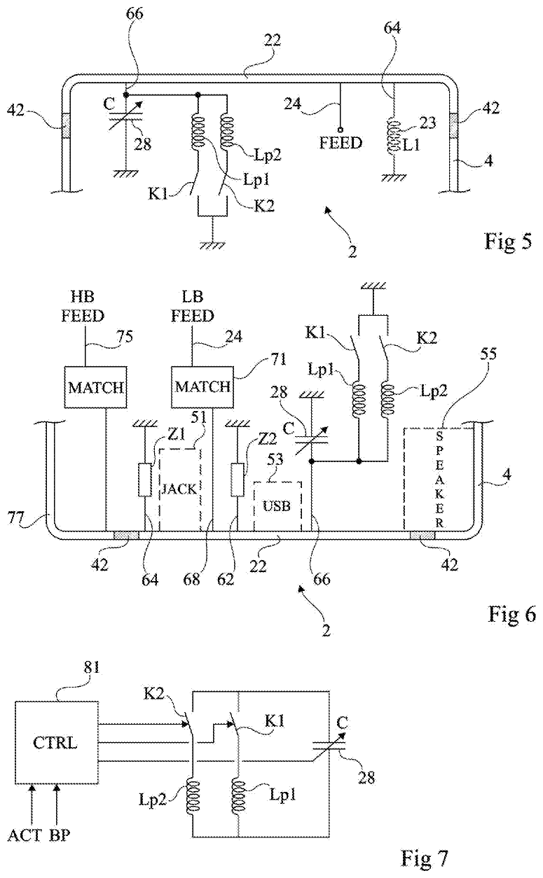

FIG. 5 schematically shows another embodiment of a PIFA antenna.

FIGS. 4 and 5 show embodiments of an antenna 2 formed on a small side of the periphery of shell 4 of a telephone. These drawings should be compared with FIGS. 2 and 3 and also consider the case of a telephone having a generally rectangular shape. However, all that will be described more generally applies to any PIFA antenna, be it or not supported by the periphery of the telephone shell. FIGS. 4 and 5 schematically show cross-section views of a portion of a telephone shell 4.

FIG. 4 illustrates the case of an antenna 2 having a length such that it is integrally contained in the small side of the periphery of shell 4.

FIG. 5 illustrates the case of an antenna 2 having a length requiring for it to protrude from the small side. Antenna 2 thus partially extends on the lateral edges of shell 4.

According to the described embodiments, one can find conductive strip 22, feed 24, and variable-capacitance capacitive element 28.

Two inductive elements Lp1 and Lp2 are each series connected with a switch K1, respectively K2, and each series association is connected in parallel with capacitive element 28. Parallel connection means that inductive elements Lp1 and Lp2 are connected to capacitive element 28 either directly or via switches K1 and K2, with no portion of strip 22 providing connectivity. In other words, elements 28, Lp1 and Lp2 share a same point 66 of connection to strip 22 at a conductive line that directly electrically connects to the strip 22. For the capacitive element 28 and inductive elements Lp1 and Lp2 these exists only one physical connection point on the body of the strip 22 for making the electrical connection.

The function of inductive elements Lp1 and Lp2 is to add an inductance in parallel with capacitive element 28. This inductance enables to improve the variation range of adjustable capacitive element 28 and thus to widen the bandwidth towards low frequencies, while easing the tuning and the selection of the low frequencies.

Further, due to the switching between inductances Lp1 and Lp2, it is now possible to compensate for disturbances caused by the activation of a USB-type port or the like in the vicinity of conductive strip 22 and, according to the desired operating frequency band, adjust the inductance value added in parallel on capacitor 28.

Preferably, there is no direct connection of strip 22 to ground. In other words, if an additional inductance 23 (L1) coupling strip 22 to ground from another point 64 of connection than point 66 is provided, this inductance is of value L1 greater, by a ratio of at least 5, preferably in the order of 10 times greater, than a parasitic inductance introduced by a direct connection to ground.

The inductance value introduced by each inductive element Lp1, Lp2 is greater than the value of inductance L1 (typically a parasitic or a low-value inductance) introduced by the ground connection. Preferably, the value of each inductance Lp1, Lp2 is at least 5 times greater, preferably in the order of 10 times greater, than the value of a parasitic inductance created by a direct connection of strip 22 to ground. For example, the value of each inductance Lp1, Lp2 is at least 5 nH, preferably at least 10 nH.

Switches K1 and K2 are preferably switches of series or SPST (Single Pole, Single Throw) type. Preferably, switches K1 and K2 are off in the idle state.

Referring to the orientation of FIGS. 4 and 5, PIFA antenna 2 is formed in the small upper side of shell 4 of the telephone. This may, for example, apply to the case of a telephone comprising external connectors in this upper portion. However, the same type of antenna may be formed in the lower portion of shell 4 which, for recent telephones (smart phones), generally comprises the access to the USB/OTG connector/port and to other connectors.

FIG. 6 shows a simplified cross-section view of another embodiment of a PIFA antenna. This drawing illustrates the case of an antenna 2 formed in the lower small side of shell 4 of the telephone.

As a specific embodiment, the case of an antenna 2 formed with a strip 22 of the type of that in FIG. 4 is considered. However, what is described hereafter also applies to a strip of the type of that of FIG. 5, or even to strips arranged in other portions of the telephone.

The drawing shows, in addition to conductive strip 22, feed 24, and capacitive element 28. It also shows switchable inductive elements Lp1 and Lp2, here also, two in number.

The example of FIG. 6 assumes the presence of an impedance Z1, for example essentially formed of inductive component 23, coupling point 64 of strip 22 to ground. The presence of another impedance Z2 coupling strip 22 to ground from another point 62 and preferably mainly formed of an inductance is also considered. The position of connection 62 of impedance Z2 to strip 22 is located between points 64 and 66, of connection of inductance Z1 to element 28 (and of inductances Lp1 and Lp2) to strip 22.

FIG. 6 illustrates the presence, in the telephone, of a jack-type connector 51 (JACK), for example, for headphones, of a USB- or USB-OTG-type connector 53 (USB), and of a loudspeaker 55 (SPEAKER). The connectors emerge into openings (not shown) of the lower portion of shell 4, that is, at the level of strip 22. For example, connector 53 is approximately in the middle of the lower side of the shell, connector 51 is more to the left and connector 55 is more to the right.

Preferably, point 66 of connection of the parallel association of capacitive element 28 and of inductances Lp1 and Lp2 is located between connectors 53 and 55. Further, points 62 and 64 of connection of impedances Z2 and Z1 are located on either side of connector 51, point 62 being between connectors 51 and 53.

In practice, strip 22 comprises openings of access to the connectors.

As a specific embodiment, in mobile telephony applications, with a conductive strip 22 having a length in the range from 5 to 10 centimeters, the value of inductances Lp1 and Lp2 is in the range from some ten nanohenries to a few tens of nanohenries. The order of magnitude of the value of capacitance C of capacitive element 28 is one picofarad. Such an antenna enables to decrease the low band to approximately 600 MHz, or even less.

FIG. 6 also illustrate the presence, between feed 24 (its point 68 of connection to strip 22) and the telephone processing circuits, of an impedance matching network 71 (MATCH). FIG. 6 also illustrates the presence, not only of a feed 24 of connection to strip 22, more particularly configured for low-frequency bands (LB FEED), but also of a feed 73, configured for higher frequency bands (HB FEED), coupled by an impedance matching network 75 (MATCH) to another PIFA antenna 77, supported by shell 4, for example, in the left-hand portion thereof. The function of this antenna then is to cover other frequencies, for example, higher, for example from 1.7 GHz to 3 GHz.

As a specific embodiment, the low-frequency bands range from approximately 400 MHz to approximately 1 GHz and the high-frequency bands are the higher frequency bands, for example up to approximately 3 GHz.

FIG. 7 is a partial block diagram of an example of a PIFA antenna tuning structure.

FIG. 7 very schematically shows an embodiment according to which a circuit 81 (CTRL), for example, integrated to circuit 14 (FIG. 1), receives not only data BP relative to the frequency band used, but also data ACT relative to the active connector(s). Such data are known by circuit 14 and are thus easily usable for circuit 81. Circuit 81 controls not only the value of capacitive element 28, but also, individually, switches K1 and K2 to place, if need be, inductance Lp1 and/or inductance Lp2 in the circuit in parallel with element 28. The control of switches K1 and K2 is in all or nothing (digital) while the control of capacitive element 28 is preferably analog.

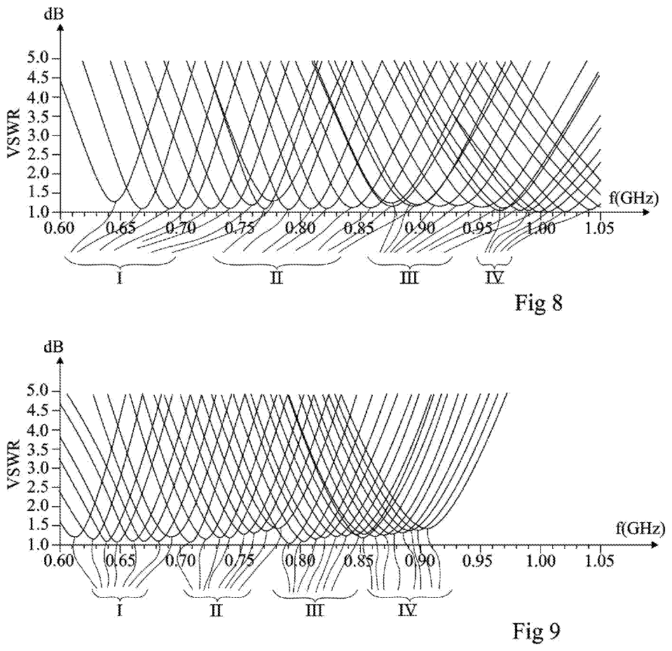

FIG. 8 illustrates an example of frequency response of a PIFA antenna such as shown in FIG. 6.

FIG. 9 illustrates another example of frequency response of a PIFA antenna such as shown in FIG. 6.

FIGS. 8 and 9 show examples of the shape of voltage standing wave rate VSWR of antenna 2 of FIG. 6 according to frequency, respectively in the absence of use of the USB-OTG port and in the presence of a connection to the USB-OTG port. In the example of FIGS. 8 and 9, the operation of antenna 2 is considered for frequencies in the range from 610 MHz to 960 MHz (grey area in FIGS. 8 and 9).

The examples of FIGS. 8 and 9 correspond to measurements obtained for an antenna 2 having the following characteristics: length of strip 22: approximately 4.7 cm; capacitance of element 28: approximately 1.5 pF; inductance Lp1: approximately 36 nH; inductance Lp2: approximately 15 nH.

The responses plotted in FIGS. 8 and 9 for the different frequencies are distributed in four categories according to the configuration of switches K1 and K2:

I: the two switches are off and none of inductances Lp1 and Lp2 is thus inserted in the assembly;

II: only switch K1 is on and inductance Lp1 of 36 nH is thus inserted in the assembly;

III: only switch K2 is on and inductance Lp2 of 15 nH is thus inserted in the assembly; and

IV: the two switches K1 and K2 are on and inductances Lp1 and Lp2 are in parallel (having an equivalent value of approximately 10 nH) are inserted in the assembly.

As illustrated in FIGS. 8 and 9, the insertion of inductance(s) Lp1 or Lp2 enables to widen the acceptable operating frequency band, that is, with a voltage standing wave ratio smaller than 3. Further, regardless of whether the USB port is used (FIG. 9) or not (FIG. 8), the operation band covers the entire frequency range from approximately 610 MHz to approximately 960 MHz.

The use of inductive elements Lp1 and Lp2 enables to limit the degradation of the voltage standing wave ratio generated by the use of the USB port, and thus to limit to less than 5 dB the degradation of the total radiated power (TRP).

Similarly to what has just been discussed in relation with the example of a USB-OTG connector, inductance network Lp1 and Lp2 may be used on use (activation) of other components of the telephone, close to the antenna such as, for example, the headphone or jack socket, the loudspeaker, a microphone, etc.

The impact of an activation of the different ports on the frequency response of the antenna can be easily determined on design based on analyses and simulations.

An advantage of the described embodiments is that they enable to easily compensate for degradations of the voltage standing wave rate caused by the activation of a USB connection, a headphone socket, a loudspeaker, etc. This enables to improve the performance of the antenna in terms of total radiated power (TRP) in transmit mode and of total isotropic sensitivity (TIS) in receive mode.

Another advantage of the described embodiments is that they require no modification of strip 22 and are thus compatible with current telephone shells. Indeed, the added components (inductances Lp1 and Lp2 and switches K1 and K2) may be assembled on the electronic board supporting the capacitive element.

Another advantage of the described embodiments is that the correction provided by the inductive elements, combined with the variation of capacitance C, enables to correct the response of the antenna, particularly in terms of total radiated power and of total isotropic sensitivity, not only regarding the use of the USB connector, but also regarding other disturbing elements such as, for example, the plugging of headphones on a jack socket, the operation of the loudspeaker, etc.

Various embodiments and variations have been described. It should be understood by those skilled in the art that certain features of these various embodiments and variations may be combined, and other variations will occur to those skilled in the art. In particular, the number of inductances in parallel with capacitive element 28 may be different from 2. However, a number of 2 or 3 elements is an advantageous tradeoff between the obtained frequency correction and the generated additional bulk.

Finally, the practical implementation of the described embodiments and variations is within the abilities of those skilled in the art based on the functional indications given hereabove. In particular, the selection of the values of inductances Lp1 and Lp2 and of the variation range of capacitance C is within the abilities of those skilled in the art particularly according to the application and to the considered frequency bands.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. An antenna, comprising:
an elongated conductive strip;
a conductive line that directly electrically connects to the elongated conductive strip;
at least one capacitive element of adjustable capacitance coupled between said conductive line and a ground; and
at least one inductive element coupled between said conductive line and the ground in parallel with the at least one capacitive element.

2. The antenna of claim 1, comprising at least two inductive elements coupled between said conductive line and the ground in parallel with the at least one capacitive element.

3. The antenna of claim 2, comprising a controllable switch coupled in series with each inductive element between said conductive line and the ground.

4. The antenna of claim 3, wherein two controllable switches are respectively associated with two inductive elements and are controllable according to four states:
the two controllable switches are off;
a first one of the controllable switches is on, the second one of the controllable switches being off;
the second of the controllable switch is on, the first one of the controllable switches being off; and
the two controllable switches are on.

5. The antenna of claim 2, further comprising a control circuit configured to switch the inductive element according to an activation of a component of a device utilizing the antenna, said switching performed independent from the antenna.

6. The antenna of claim 11, wherein the control circuit is further configured to adjust a capacitance of the capacitive element according to the activation of the component of the device, said adjusting performed independent from the antenna.

7. The antenna of claim 2, further comprising a control circuit configured to switch the inductive element according to a frequency band for operation of the antenna.

8. The antenna of claim 1, wherein a terminal of the at least one capacitive element and a terminal of the at least one inductive element are directly physically and electrically connected to the conductive line.

9. The antenna of claim 1, wherein only a single direct physical and electrical connection is provided to the elongated conductive strip itself for both the at least one capacitive element and the at least one inductive element.

10. The antenna of claim 1, wherein an inductance value of the at least one inductive element is at least 5 nH.

11. The antenna of claim 1, wherein an inductance value of the at least one inductive element is at least 10 nH.

12. The antenna of claim 1, forming a shorted quarter-wave antenna.

13. The antenna of claim 1, sized for bandwidths in a range from approximately 610 MHz to approximately 960 MHz.

14. The antenna of claim 1, further comprising a control circuit configured to adjust a capacitance of the capacitive element according to a frequency band for operation of the antenna.

15. A portable telecommunication device, comprising:
a shell; and
an antenna;
wherein the shell has a periphery which integrally contains an elongated conductive strip of the antenna;
the antenna further comprising:
a conductive line that directly electrically connects to the elongated conductive strip;
at least one capacitive element of adjustable capacitance coupled between said conductive line and a ground; and
at least one inductive element coupled between said conductive line and the ground in parallel with the at least one capacitive element.

16. The device of claim 15, comprising a USB connector in an opening of the elongated conductive strip at the periphery of the shell.

17. The device of claim 16, wherein the antenna further comprises at least two inductive elements coupled between said conductive line and the ground in parallel with the at least one capacitive element.

18. The device of claim 17, further comprising a controllable switch coupled in series with each inductive element between said conductive line and the ground.

19. The device of claim 18, further comprising a control circuit configured to switch the inductive element according to an activation of a component of a device utilizing the antenna, said switching performed independent from the antenna.

20. The device of claim 19, wherein the control circuit is further configured to adjust a capacitance of the capacitive element according to the activation of the component of the device, said adjusting performed independent from the antenna.

21. The device of claim 18, further comprising a control circuit configured to switch the inductive element according to a frequency band for operation of the antenna.

22. The device of claim 18, wherein the switching of the controllable switches for the inductive elements depends on whether the USB connector is being used.

23. The device of claim 22, wherein two controllable switches are respectively associated with two inductive elements and are controllable according to four states:
the two controllable switches are off;
a first one of the controllable switches is on, the second one of the controllable switches being off;
the second of the controllable switch is on, the first one of the controllable switches being off; and
the two controllable switches are on.

24. The device of claim 15, comprising a jack connector in an opening of the elongated conductive strip at the periphery of the shell.

25. The device of claim 15, wherein a terminal of the at least one capacitive element and a terminal of the at least one inductive element are directly physically and electrically connected to the conductive line.

26. The device of claim 15, wherein only a single direct physical and electrical connection is provided to the elongated conductive strip itself for both the at least one capacitive element and the at least one inductive element.

27. The device of claim 15, wherein an inductance value of the at least one inductive element is at least 5 nH.

28. The device of claim 15, wherein an inductance value of the at least one inductive element is at least 10 nH.

29. The device of claim 15, forming a shorted quarter-wave antenna.

30. The device of claim 15, sized for bandwidths in a range from approximately 610 MHz to approximately 960 MHz.

31. The device of claim 15, further comprising a control circuit configured to adjust a capacitance of the capacitive element according to a frequency band for operation of the antenna.
